(19) United States
(12) Patent Application Publication
(10) Pub. No.: US 2006/0182975 A1
(43) Pub. Date: Aug. 17, 2006

(54) Thermoset polymer substrates

(75) Inventors: Allen Burbank, Youngsville, NC (US); Kenneth Lipovsky, Durham, NC (US); Eric Dumain, Hillsborough, NC (US)

Correspondence Address: MYERS BIGEL SIBLEY & SAJOVEC, PO BOX 37428, RALEIGH, NC, 27627, US

(73) Assignee: Reichhold, Inc.

(21) Appl. No.: 11/282,137

(22) Filed: Nov. 18, 2005

Related U.S. Application Data
(60) Provisional application No. 60/653,871, filed on Feb. 17, 2005.

(51) Int. Cl. B32B 7/04

(52) U.S. Cl. 428/420; 524/495; 427/475

(57) ABSTRACT

The present invention provides a thermoset polymer substrate having applied thereto an ionizable compound and an electrostatic powder coating. In an embodiment, the present invention provides a thermoset polymer substrate having an image on at least one surface thereof, said substrate having applied thereto an ionizable compound, an electrostatic powder coating, and a carrier for transferring the image thereon. Methods of providing a powder coating composition on a substrate, and methods of providing an image on at least one surface of the substrate are also presented.

### RELATED APPLICATION

This application claims priority from U.S. Provisional Application No. 60/653,871; filed Feb. 17, 2005, the disclosure of which is incorporated by reference herein in its entirety.

### FIELD OF THE INVENTION

The present invention relates to thermoset polymer substrates having applied thereto an electrostatic powder coating.

### BACKGROUND OF THE INVENTION

Since ancient times marble and granite have been extensively used for building and ornamental purposes. The beauty and durability of these stones make them a first choice as a product for interior and exterior home and building decoration. However, since marble and granite are natural products, their structure is not homogeneous and possesses fractures and impurities that may adversely affect their physical properties. These imperfections compromise the integrity of the stones and make them more unpredictable.

Simulated or synthetic stone surfaces have become a popular building material. Various commercial processes have been developed for the production of simulated or synthetic marble, onyx and granite. These products are typically made by casting operations to form sinks, shower walls, shower pans, simulated tile walls, soap dishes, bathtubs, integral bowls, ceiling & floor tiles, columns, decorative moldings, furniture, countertops, etc. The most common process involves a mold having a predetermined configuration which is initially coated by a hardenable thermosetting resin coating generally referred as “gelcoat”. After the gelcoat is applied, a thermosetting resin such as unsaturated polyester resin mixed with a filler is cast over the gelcoat. Once the mixture has “cured” the part is demolded. Some of these processes may also include fiber reinforcements such as glass fiber.

Advantages on the preparation and commercialization of simulated or synthetic stone surfaces are that a variety of features may be designed and adapted to the finished materials. Contactors or homeowners can design living spaces where the prefabricated “synthetic marble” is built to a required specification then installed at the appropriate living spaces. Examples of these processes are found for example in U.S. Pat. Nos. 6,187,415; 6,003,169; 5,063,093; 4,446,177; 4,244,993 and 4,209,486, the disclosures of which are incorporated herein by reference in their entireties.

A drawback on the preparation of synthetic stone surfaces is the large amounts of volatile organic compounds (VOC) emitted during the application of the gelcoats. In general, gelcoat often have a large amount of styrene and/or methyl methacrylate or other volatile monomers which during the coating application over the surface of the mold, a large evaporation of the monomers is emitted. In addition, during the curing process more VOC are released to the environment due to high exotherm of polymerizations that may exceed the boiling point of the monomers.

The reduction of VOC is an important topic in the application of thermosetting coatings. As a result, new environmentally friendly methods and coatings are required to overcome the problems of emitting organic vapors to the atmosphere. At present, there is a continuous strive for the development of an “ideal” coating. In an ideal situation, the coating may apply easily, with maximum material utilization and in a high speed. The coating should be super durable, available in various colors and in different gloss levels, colors and aesthetics. In addition, the coating should be environmentally friendly and curing does not lead to the emission of VOC. Additionally, the energy required during the curing process should be low. This is important for those situations where the substrate deforms at relatively low temperatures. It has become common to replace gelcoats with powder coatings to reduce VOCs.

Applying powder coating to nonconductive substrates, however can be difficult. This can be a challenging step which requires careful attention to have a perfectly conductive substrate, so that the powder is uniformly distributed on the surface.

Thus, there remains a need to have a nonconductive thermoset substrate able to receive powder coating material onto its surface that will not have problems related to emitting VOC and have excellent resistance to degradation and superior aesthetic appearance. There is also a need to provide decorative images on nonconductive thermoset substrates to provide a wide variety of aesthetic effects.

### SUMMARY OF THE INVENTION

To this end, the present invention provides a thermoset polymer substrate having applied thereto an ionizable compound and an electrostatic powder coating. In an embodiment, the present invention provides a thermoset polymer substrate having an image on at least one surface thereof, said substrate having applied thereto an ionizable compound, an electrostatic powder coating, and a carrier for transferring the image thereon. Methods of providing a powder coating composition on a substrate, and methods of providing an image on at least one surface of the substrate are also presented.

### DETAIL DESCRIPTION OF THE INVENTION

The present invention relates to a method for the electrostatic coating of a nonconductive thermoset polymer substrate. The present invention relates to the preparation of products coated with powder materials that can enhance the surface and durability of the materials. Depending on the final intended application, the substrates are prepared from a variety of thermosetting materials that can be used alone or preferable in combination with organic or inorganic fillers. An ionizable organic compound is coated over or onto at least one surface of the substrate allowing the charged particles of the powder coating to deposit onto it. Curing is then performed at the appropriate temperature to allow the powder coating to melt, flow, react and crosslink.

A wide variety of images can also be applied on or transferred to a wide variety of substrates. Such substrates can be made into a myriad of articles of manufacture such as popular building materials and articles including architectural facings, exterior and internal wall panels, floors and the like, and specifically including bathroom sinks, shower walls, bathtubs, shower pans, soap dishes, and other fixtures, countertops, and table tops. Such articles can have applied thereto an image to provide a wide variety of aesthetic effects.

I. Substrate Compositions

A variety of thermosetting resins and additives can be used in the preparation of the substrate. Examples include but are not limited to unsaturated polyesters, vinyl esters, urethane acrylates, and epoxy materials. For the purpose of the invention, unsaturated polyester resins, saturated polyester resins and vinyl ester resins are preferably employed. An unsaturated polyester resin may be formed from conventional methods. Typically, the resin is formed from the reaction between a polyfunctional organic acid or anhydride and a polyhydric alcohol under conditions known in the art. The polyfunctional organic acid or anhydride which may be employed are any of the numerous and known compounds. Suitable polyfunctional acids or anhydrides thereof include, but are not limited to, maleic acid, fumaric acid, citraconic acid, itaconic acid, glutaconic acid, phthalic acid, isophthalic acid, terephthalic acid, tetrahydrophthalic anhydride, cyclohexane dicarboxylic acid, succinic anhydride, adipic acid, sebacic acid, azelaic acid, malonic acid, alkenyl succinic acids such as n-dodecenyl succinic acid, dodecylsuccinic acid, octadecenyl succinic acid, and anhydrides thereof. Lower alkyl esters of any of the above may also be employed. Mixtures of any of the above are suitable, without limitation intended by this.

Additionally, polybasic acids or anhydrides thereof having not less than three carboxylic acid groups may be employed. Such compounds include 1,2,4-benzenetricarboxylic acid, 1,3,5-benzene tricarboxylic acid, 1,2,4-cyclohexane tricarboxylic acid, 2,5,7-naphthalene tricarboxylic acid, 1,2,4-naphthalene tricarboxylic acid, 1,3,4-butane tricarboxylic acid, 1,2,5-hexane tricarboxylic acid, 1,3-dicarboxyl-2-methyl-2-carboxymethylpropane, tetra(carboxymethyl)methane, 1,2,7,8-octane tetracarboxylic acid, and mixtures thereof.

Suitable polyhydric alcohols which may be used in forming the unsaturated polyester resins include, but are not limited to, ethylene glycol, diethylene glycol, propylene glycol, dipropylene glycol, 1,3-butanediol, 1,4-butanediol, 1,3-hexanediol, neopentyl glycol, 2-methyl-1,3-propanediol, 1,3-butylene glycol, 1,6-hexanediol, hydrogenated bisphenol “A”, cyclohexane dimethanol, 1,4-cyclohexanol, ethylene oxide adducts of bisphenols, propylene oxide adducts of bisphenols, sorbitol, 1,2,3,6-hexatetrol, 1,4-sorbitan, pentaerythritol, dipentaerythritol, tripentaerythritol, sucrose, 1,2,4-butanetriol, 1,2,5-pentanetriol, glycerol, 2-methyl-propanetriol, 2-methyl-1,2,4-butanetriol, trimethylol ethane, trimethylol propane, and 1,3,5-trihydroxyethyl benzene. Mixtures of any of the above alcohols may be used.

DCPD resins used in the composition of the invention are known to those skilled in the art. These resins are typically DCPD polyester resins and derivatives which may be made according to various accepted procedures. As an example, these resins may be made by reacting DCPD, ethylenically unsaturated dicarboxylic acids, and compounds having two groups wherein each contains a reactive hydrogen atom that is reactive with carboxylic acid groups. DCPD resins made from DCPD, maleic anhydride phthalic anhydride, isophthalic acid, terephthalic acid, adipic acid, water, and a glycol such as, but not limited to, ethylene glycol, propylene glycol, diethylene glycol, neopentyl glycol, dipropylene glycol, and poly-tetramethylene glycol; are particularly preferred for the purposes of the invention. The DCPD resin may also include nadic acid ester segments that may be prepared in-situ from the reaction of pentadiene and maleic anhydride or added in its anhydride form during the preparation of the polyester. Examples on the preparation of DCPD unsaturated polyester resins can be found in U.S. Pat. Nos. 3,883,612 and 3,986,922, the disclosures of which are incorporated herein by reference in their entireties.

The unsaturated polyester resin may be used in various amounts in the resin composition of the invention. The resin composition often comprises from about 10 to about 80 weight percent of unsaturated polyester resin, and sometimes from about 20 to about 40 weight percent. The unsaturated polyester resin often has a number average molecular weight ranging from about 700 to about 10,000, and sometimes from about 800 to about 5,000. Additionally, the unsaturated polyester resin often has an ethylenically unsaturated monomer content of below 35 percent at an application viscosity of 200 to 3,000 cps.

Vinyl Esters

The vinyl ester resins employed in the invention include the reaction product of an unsaturated monocarboxylic acid or anhydride with an epoxy resin. Exemplary acids and anhydrides include (meth)acrylic acid or anhydride, α-phenylacrylic acid, α-chloroacrylic acid, crotonic acid, mono-methyl and mono-ethyl esters of maleic acid or fumaric acid, vinyl acetic acid, sorbic acid, cinnamic acid, and the like, along with mixtures thereof. Epoxy resins which may be employed are known and include virtually any reaction product of a polyfunctional halohydrin, such as epichlorohydrin, with a phenol or polyhydric phenol. Suitable phenols or polyhydric phenols include, for example, resorcinol, tetraphenol ethane, and various bisphenols such as Bisphenol “A”, 4,4′-dihydroxydiphenyl sulfone, 4,4′-dihydrohy biphenyl, 4,4′-dihydroxydiphenyl methane, 2,2′-dihydoxydiphenyloxide, and the like. Novolac epoxy resins may also be used. Mixtures of any of the above may be used. Additionally, the vinyl ester resins may have pendant carboxyl groups formed from the reaction of esters and anhydrides and the hydroxyl groups of the vinyl ester backbone.

Other components in the resin may include epoxy acrylate oligomers known to those who are skilled in the art. As an example, the term “epoxy acrylates oligomer” may be defined for the purposes of the invention as a reaction product of acrylic acid and/or methacrylic acid with an epoxy resin. Examples of processes involving the making of epoxy acrylates can be found in U.S. Pat. No. 3,179,623, the disclosure of which is incorporated herein by reference in its entirety. Epoxy resins that may be employed are known and include virtually any reaction product of a polyfunctional halohydrin, such as, but not limited to, epichlorohydrin, with a phenol or polyhydric phenol. Examples of phenols or polyhydric phenols include, but are not limited to, resorcinol, tetraphenol ethane, and various bisphenols such as bisphenol-A, 4,4′-dihydroxy biphenyl, 4,4′-dihydroxydiphenylmethane, 2,2′-dihydroxydiphenyloxide, phenol or cresol formaldehyde condensates and the like. Mixtures of any of the above can be used. The preferred epoxy resins employed in forming the epoxy acrylates are those derived from bisphenol A, bisphenol F, especially preferred are their liquid condensates with epichlorohydrin having a molecular weight preferably in the range of from about 500 to about 5,000. The preferred epoxy acrylates that are employed of the general formula: 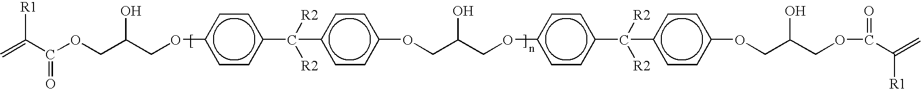
where R₁ and R₂ is H or CH₃ and n ranges from 0 to 1, more preferably from 0 to 0.3. Other examples of epoxy acrylate oligomers that may be used include comparatively low viscosity epoxy acrylates. As an example, these materials can be obtained by reaction of epichlorohydrin with the diglycidyl ether of an aliphatic diol or polyol.
Polyurethane Acrylates

Polyacrylates are also useful in the present invention for the preparation of the molding compositions. A urethane poly(acrylate) characterized by the following empirical formula may used as part of the mixtures: 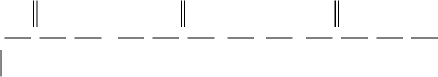
wherin R₁ is hydrogen or methyl; R₂ is a linear or branched divalent alkylene or oxyalkylene radical having from 2 to 5 carbon atoms; R₃ is a divalent radical remaining after reaction of a substituted or unsubstituted diisocyanate; R₄ is the hydroxyl free residue of an organic polyhydric alcohol which contained hydroxyl groups bonded to different atoms; and f has an average value of from 2 to 4. The compounds are typically the reaction products of polyols in which the hydroxyl groups are first reacted with a diisocyanate using one equivalent of diisocyanate per hydroxyl group, and the free isocyanate groups are the reacted with a hydroxyalkyl ester of acrylic or methacrylic acid.

The polyhydric alcohol suitable for preparing the urethane poly(acrylate) typically contains at least two carbon atoms ad may contain from 2 to 4, inclusive, hydroxyl groups. Polyols based on the polycaprolactone ester of a polyhydric alcohol such as described in, for example U.S. Pat. No. 3,169,945 are included; unsaturated polyols may also be used such as those described in U.S. Pat. Nos. 3,929,929 and 4,182,830, the disclosures of which are incorporated herein by reference in their entireties.

Diisocyanates suitable for preparing the urethane poly(acrylate) are well known in the art and include aromatic, aliphatic, and cycloaliphatic diisocyanates. Such isocyanates may be extended with small amounts of glycols to lower their melting point and provide a liquid isocyanate. The hydroxyalkyl esters suitable for final reaction with the polyisocyanate formed from the polyol and diisocyanate are exemplified by hydroxylacrylate, hydroxypropyl acrylate, hydroxyethyl methacrylate, and hydroxypropyl methacrylate. Any acrylate or methacrylate ester or amide containing an isocyanate reactive group may be used herein, however.

Urethane poly(acrylates) such as the above are described in for example, U.S. Pat. Nos. 3,700,643; 4,131,602; 4,213,837; 3,772,404 and 4,777,209, the disclosures of which are incorporated herein by reference in their entireties.

A urethane poly(acrylate) characterized by the following empirical formula: 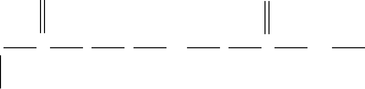
where R₁ is hydrogen or methyl; R₂ is a linear or branched alkylene or oxyalkylene radical having from 2 to about 6 carbon atoms; R₃ is the polyvalent residue remaining after the reaction of a substituted or unsubstituted polyisocyanate; and g has an average value of from about 2 to 4. These compounds are typically the reaction products of a polyisocyanate with a hydroxyalkyl ester per isocyanate group.

Polyisocyanates suitable for preparing the urethane poly(acrylates) are well known in the art and include aromatic, aliphatic and cycloaliphatic polyisocyanates. Some diisocyanates may be extended with small amounts of glycol to lower their melting point and provide a liquid isocyanate. Urethanes poly(acrylates) such as the above are described in, for example U.S. Pat. No. 3,297,745 and British Pat. No. 1,159,552, the disclosure of which are incorporated herein by reference in their entireties.

A half-ester or half-amide characterized by the following formula: 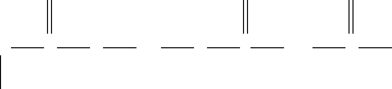
wherein R₁ is hydrogen or methyl. R₂ is an aliphatic or aromatic radical containing from 2 to about 20 carbon atoms, optionally containing —O or 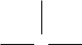
W and Z are independently —O— or 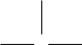
and R₃ is hydrogen or low alkyl. Such compounds are typically the half-ester or half-amide product formed by the reaction of a hydroxyl, amino, or alkylamino containing ester or amide derivatives of acrylic or methacrylic acid with maleic anhydride, maleic acid, or fumaric acid. These are described in, for example, U.S. Pat. Nos. 3,150,118 and 3,367,992, the disclosures of which are incorporated herein by reference in their entireties.
Isocyanurate Acrylates

An unsaturated isocyanurate characterized by the following empirical formula: 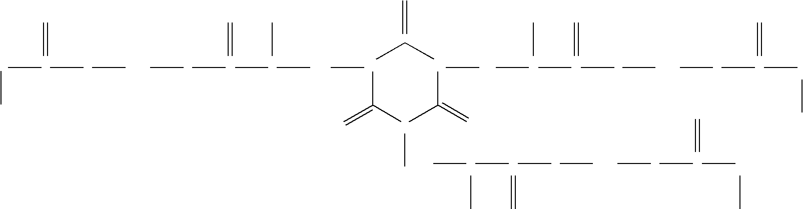
wherein R₁ is a hydrogen or methyl, R₂ is a linear or branched alkylene or oxyalkylene radical having from 2 to 6 carbon atoms, and R₃ is a divalent radical remaining after reaction of a substituted or unsubstituted diisocyanate. Such products are typically produced by the reaction of a diisocyanate reacted with one equivalent of a hydroxyalkyl ester of acrylic or methacrylic acid followed by the trimerization reaction of the remaining free isocyanate.

It is understood that during the formation of the isocyanurate, a diisocyanate may participate in the formation of two isocyanurate rings thereby forming crosslinked structures in which the isocyanurate rings may be linked by the diisocyanate used. Polyiisocyanates might also be used to increase this type of crosslink formation.

Diisocyanates suitable for preparing the urethane poly(acrylate) are well known in the art and include aromatic, aliphatic, and cycloaliphatic diisocyanates. Such isocyanates may be extended with small amounts of glycols to lower their melting point and provide a liquid isocyanate.

The hydroxyalkyl esters suitable for final reaction with the polyisocyanate formed from the polyol and diisocyanate are exemplified by hydroxylacrylate, hydroxypropyl acrylate, hydroxyethyl methacrylate, and hydroxypropyl methacrylate. Any acrylate or methacrylate ester or amide containing an isocyanate reactive group may be used herein, however. Other alcohols containing one hydroxyl group may also be used. The monoalcohols may be monomeric or polymeric.

Such unsaturated isocyanurates are described in, for example, U.S. Pat. No. 4,195,146, the disclosure of which is incorporated herein by reference in its entirety.

Polyamide Ester Acrylates

Poly(amide-esters) as characterized by the following empirical formula: 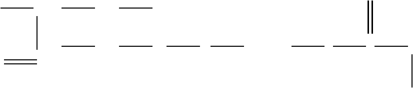
wherein R₁ is independently hydrogen or methyl, R₂ is independently hydrogen or lower alkyl, and h is 0 or 1. These compounds are typically the reaction product of a vinyl addition prepolymer having a plurality of pendant oxazoline or 5,6-dihydro-4H-1,3-oxazine groups with acrylic or methacrylic acid. Such poly(amide-esters) are described in, for example, British Pat. No. 1,490,308, the disclosure of which is incorporated herein by reference in its entirety.

A poly(acrylamide) or poly(acrylate-acrylamide) characterized by the following empirical fomula: 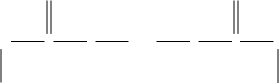
wherein R₁ is the polyvalent residue of an organic polyhydric amine or polyhydric aminoalcohol which contained primary or secondary amino groups bonded to different carbon atoms or, in the case of an aminoalcohol, amine and alcohol groups bonded to different carbon atoms; R₂ and R₃ are independently hydrogen or methyl; K is independently O or 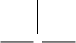
R₄ is hydrogen or lower alkyl; and i is 1 to 3.

The polyhydric amines suitable for preparing the poly(acrylamide) contains at least two carbon atoms and may contain 2 to 4, inclusive, amine or alcohol groups, with the proviso that at least one group is a primary or a secondary amine. These include alkane aminoalcohols and aromatic containing aminoalcohols. Also included are polyhydric aminoalcohols containing ether, amino, amide, and ester groups in the organic residue.

Examples of the above compounds are described, in for example, Japanese publications Nos. JP80030502, JP80030503, and JP800330504 and U.S. Pat. No. 3,470,079 and British Pat. No. 905,186, the disclosures of which are incorporated herein by reference in their entireties.

It is understood by those skilled in the art that the thermosetable organic materials described, supra, are only representative of those which may be used in the practice of this invention.

Thermoplastic Polymers—Low Profile Agents

Thermoplastic polymeric materials which reduce shrinkage during molding can also be included in the composition of the invention. These thermoplastic materials can be used to produce molded articles having surfaces of improve smoothness. The thermoplastic resin is added into the unsaturated polyester composition according to the invention in order to suppress shrinkage at the time of curing. The thermoplastic resin is provided in a liquid form and is prepared in such a manner that 30 to 45% by weight of the thermoplastic resin is dissolved in 55 to 70% by weight of polymerizable monomer having some polymerizable double bond in one molecule. Examples of the thermoplastic resin may include styrene-base polymers, polyethylene, polyvinyl acetate base polymer, polyvinyl chloride polymers, polyethyl methacrylate, polymethyl methacrylate or copolymers, ABS copolymers, Hydrogenated ABS, polycaprolactone, polyurethanes, butadiene styrene copolymer, and saturated polyester resins. Additional examples of thermoplastics are copolymers of: vinyl chloride and vinyl acetate; vinyl acetate and acrylic acid or methacrylic acid; styrene and acrylonitrile; styrene acrylic acid and allyl acrylates or methacrylates; methyl methacrylate and alkyl ester of acrylic acid; methyl methacrylate and styrene; methyl methacrylate and acrylamide. In the resin composition according to the invention, 5 to 50% by weight of the liquid thermoplastic resin is mixed, preferably 10 to 30% by weight of the liquid thermoplastic resin is mixed.

Low profile agents (LPA) are composed primarily of thermoplastic polymeric materials. These thermoplastic intermediates present some problems remaining compatible with almost all types of thermosetting resin systems. The incompatibility between the polymeric materials introduces processing difficulties due to the poor homogeneity between the resins. Problems encountered due to phase separation in the resin mixture include, scumming, poor color uniformity, low surface smoothness and low gloss. It is therefore important to incorporate components that the will help on stabilizing the resin mixture to obtain homogeneous systems that will not separate after their preparation. For this purpose, a variety of stabilizers can be used in the present invention which includes block copolymers from polystyrene-polyethylene oxide as those described in U.S. Pat. Nos. 3,836,600 and 3,947,422, the disclosures of which are incorporated herein by reference in their entireties. Block copolymer stabilizers made from styrene and a half ester of maleic anhydride containing polyethylene oxide as described in U.S. Pat. No. 3,947,422. Also useful stabilizers are saturated polyesters prepared from hexanediol, adipic acid and polyethylene oxide available from BYK Chemie under code number W-972. Other type of stabilizers may also include addition type polymers prepared from vinyl acetate block copolymer and a saturated polyester as described in Japanese Unexamined Patent application No. Hei 3-174424.

Epoxy Intermediates

Also compounds that may be included in this invention are epoxy compounds which include a wide variety of epoxy compounds. Typically, the epoxy compounds are epoxy resins which are also referred as polyepoxides. Polyepoxides useful herein can be monomeric (i.e., the diglycidyl ether of bisphenol A), advanced higher molecular weight resins, or polymerized unsaturated monoepoxides (i.e., glycidyl acrylates, glycidyl methacrylates, allyl glycidyl ether, etc.) to homopolymers or copolymers. Most desirable, epoxy compounds contain, on the average, at least one pendant or terminal 1,2-epoxy group (i.e., vicinal epoxy group per molecule).

Examples of the useful polyepoxides include the polyglicidyl ethers of both polyhydric alcohols and polyhydric phenols; polyglycidyl amines, polyglycidyl amides, polyglycidyl imides, polyglycidyl hydantoins, polyglycidyl thioethers, polyglycidyl fatty acids, or drying oils, epoxidized polyolefins, epoxidized diunsaturated acid esters, epoxidized unsaturated polyesters, and mixtures thereof. Numerous epoxides prepared from polyhydric phenols include those which are disclosed, for example, in U.S. Pat. No. 4,431,782, the disclosure of which is incorporated herein by reference in its entirety. Polyepoxides can be prepared from mono-, di- and trihydric phenols, and can include the novolac resins. The polyepoxides can include the epoxidized cycloolefins; as well as the polymeric polyepoxides which are polymers and copolymers of glycidyl acrylates, glycidyl methacrylate and allylglycidyl ether. Suitable polyepoxides are disclosed in U.S. Pat. Nos. 3,804,735; 3,893,829; 3,948,698; 4,014,771 and 4,119,609, the disclosures of which are incorporated herein by reference in their entireties; and Lee and Naville, Handbook of Epoxy Resins, Chapter 2, McGraw Hill, New York (1967).

While the invention is applicable to a variety of polyepoxides, generally preferred polyepoxides are glycidyl polyethers of polyhydric alcohols or polyhydric phenols having weights per epoxide of 150 to 2,000. These polyepoxides are usually made by reacting at least about two moles of an epihalohydrin or glycerol dihalohydrin with one mole of the polyhydric alcohol or polyhydric phenol, and sufficient amount of a caustic alkali to combine with the halogen of the halohydrin. The products are characterized by the presence of more than one epoxide group, i.e., a 1,2-epoxy equivalency greater than one.

The compositions may also include a monoepoxide, such as butyl glycidyl ether, phenyl glycidyl ether, or cresyl glycidyl ether, as a reactive diluent. Such reactive diluents are commonly added to polyepoxide formulations to reduce the working viscosity thereof, and to give better wetting to the formulation.

Dilution Monomers

A vinyl monomer may also be included as a diluent with the vinyl esters, urethanes, unsaturated and saturated resins. Suitable monomers may include those such as, for example, styrene and styrene derivatives such as alpha-methyl styrene, p-methyl styrene, divinyl benzene, divinyl toluene, ethyl styrene, vinyl toluene, tert-butyl styrene, monochloro styrene, dichloro styrene, vinyl benzyl chloride, fluorostyrene, and alkoxystyrenes (e.g., paramethoxy styrene). Other monomers which may be used include, for example, diallyl phthalate, hexyl acrylate, octyl acrylate, octyl methacrylate, diallyl itaconate, diallyl maleate, hydroxyethyl acrylate, hydroxyethyl methacrylate, hydroxypropyl acrylate and hydroxypropyl methacrylate. Mixtures of the above may also be employed.

Any suitable polyfunctional acrylate may be used in the resin composition, for example, ethylene glycol dimethacrylate, butanediol dimethacrylate, hexanediol dimethacrylate, ethoxylated trimethylol propane triacrylate, trimethylolpropane tri(meth)acrylate, trimethylolpropane triacrylate, trimethylolmethane tetramethacrylate, pentaerythritol tetramethacrylate, dipentaerythritol tetramethacrylate, dipentaerythritol pentamethacrylate, dipentaerythritol hexamethacrylate, ethoxylated polyhydric phenol diacrylates and dimethacrylates containing from 1 to 30 ethylene oxide units per OH group in the phenol, propoxylated polyhydric phenol diacrylates and dimethacrylates containing from 1 to 30 propylene oxide groups per OH groups in the phenol. Examples of some useful di- and polyhydric phenols include catechol; resorcinol; hydroquinone; 4,4′-biphenol; 4,4′-ispropylidenebis(o-cresol); 4,4′-isopropylidenebis(2-phenyl phenol);alkylidenediphenols such as bisphenol A; pyrogallol; phloroglucinol; naphthalene diols; phenol/formaldehyde resins; resorcinol/formaldehyde resins; and phenol/resorcinol/formaldehyde resins. Mixtures of the above di- and polyacrylates may also be employed.

The vinyl monomers and polyfunctional acrylates used with the vinyl esters, unsaturated polyesters, saturated polyesters, and polyurethanes may be used in varying amounts, often from about 10 to 50 precent based on the weight of the components which may be dissolved therein, and more often from about 20 to 40 weight percent.

Other monomers that may be included in the compositions of the present invention are acetyl acetonates that can be monofunctional or polyfunctional. Examples include but are not limited to methyl acetoacetate, ethyl acetoacetate, t-butyl acetoacetate, ethylhexyl acetoacetate, lauryl acetoacetate, acetoacetanilide, butanediol diacetoacetate, 1,6-hexanediol diacetoacetate, neopentyl glycol diacetoacetate, cyclohexane dimethanol diacetoacetate, ethoxylated bisphenol A diacetoacetate, trimethylolpropane triacetoacetate, glycerin triacetoacetate, polycaprolantone triacetoacetate, pentaerythritol tetraacetoacetate.

Inhibitor in Resin Mixtures

Additives may also include inhibitors added to the resin mix to stop or delay any crosslinking chain reaction that might be started by the possible formation of free radicals. Because free radicals can be formed at the carbon-carbon double bonds through several different mechanisms, such as interactions between molecules with heat and light, the possibility of the formation of free radicals is quite high. Should this occur there is a good possibility that the resin could crosslink during storage. Therefore, the right amount of inhibitor in the system is necessary to minimize stability problems. Suitable inhibitor may include but are not limited to, hydroquinone (HQ), tolu-hydroquinone (THQ), bisphenol “A” (BPA), naphthoquinone (NQ), p-benzoquinone (p-BQ), butylated hydroxy toluene (BHT), Hydroquinone monomethyl ether (HQMME), monotertiary butyl hydroquinone (MTBHQ), ditertiary Butyl hydroquinone (DTBHQ), tertiary butyl catechol (TBC). Other substituted and un-substituted phenols and mixtures of the above. All nitroxide initiators can also be used as inhibitors in the present invention.

Other Additives

Additional additives include phenolic type antioxidants as those described in pages 1 to 104 in “Plastic additives”, by R. Gächter and Müller, Hanser Publishers, 1990. Include also are Mannich type antioxidants, specially phenols and naphthols, suitable for the purpose herein include hindered aromatic alcohols, such as hindered phenols and naphthols, for example, those described in U.S. Pat. No. 4,324,717, the disclosure of which is incorporated herein by reference in its entirety. Additional additives known by the skilled artisan may be employed in the resin composition of the present invention including, for example, paraffins, lubricants, flow agents, air release agents, flow agents, wetting agents, UV stabilizers, and shrink-reducing additives. Various percentages of these additives can be used in the resin compositions.

Internal release agents are often added to the molding composition according to the invention. Aliphatic metal salts such as zinc stearate, magnesium stearate, calcium stearate or aluminum stearate can be used as the internal release agent. The amount of internal release agent added is in the range of 0.5 to 5.0% by weight, more often in the range of from 0.4% to 4.0% by weight. Hence, stable release can be made at the time of demolding without occurrence of any crack on the molded product.

Fillers

Suitable filler(s) non-fibrous are inert, particulate additives being essentially a means of reducing the cost of the final product while often reducing some of the physical properties of the polymerized cured compound. Fillers used in the invention include calcium carbonate of various form and origins, silica of various forms and origins, silicates, silicon dioxides of various forms and origins, clays of various forms and origins, feldspar, kaolin, flax, zirconia, calcium sulfates, micas, talcs, wood in various forms, glass(milled, platelets, spheres, micro-balloons), plastics (milled, platelets, spheres, micro-balloons), recycled polymer composite particles, metals in various forms, metallic oxides or hydroxides (except those that alter shelf life or viscosity), metal hydrides or metal hydrates, carbon particles or granules, alumina, alumina powder, aramid, bronze, carbon black, carbon fiber, cellulose, alpha cellulose, coal (powder), cotton, fibrous glass, graphite, jute, molybdenum, nylon, orlon, rayon, silica amorphous, sisal fibers, fluorocarbons and wood flour.

The resin may also include a conductive component for making the polyester resin conductive. Exemplary conductive components include carbon black, metals such as aluminum, copper, magnesium, chromium, tin, nickel, silver, iron, titanium, and mixtures comprising any one of the foregoing metals can be incorporated into the resins as solid metal particles. Physical mixtures and true alloys such as stainless steels, bronzes, and the like, can also serve as metallic constituents of the conductive component particles. In addition, certain intermetallic chemical compounds such as borides, carbides, and the like, of these metals, (e.g., titanium diboride) can also serve as conductive constituents of the conductive component herein. Solid non-metallic, conductive filler particles such as tin oxide, indium tin oxide, and the like may also be used. In general, use of small particles of less than 150 microns is preferred. Typically the conductive component comprises 0.1 to 7.0 weight percent, and more often 2 to 4 weight percent of the resin composition.

Other methods to enhance the conductivity of the substrate is to incorporate graphite particles over the surface of the substrate of in the mixture to form the substrate. The graphite particles incorporated within the substrate enhance the conductivity of the material allowing the powder coating particles to adhere evenly over the entire surface. An example of this method is describe in WO00/490076, which is incorporated herein by reference in its entirety.

Fiber Reinforcement

Optionally, addition of fiber(s) provides a means for strengthening or stiffening the polymerized cured composition forming the substrate. The types often used are:

Inorganic crystals or polymers, e.g., fibrous glass, quartz fibers, silica fibers, fibrous ceramics, e.g., alumina-silica (refractory ceramic fibers); boron fibers, silicon carbide, silicon carbide whiskers or monofilament, metal oxide fibers, including alumina-boria-silica, alumina-chromia-silica, zirconia-silica, and others;

Organic polymer fibers, e.g., fibrous carbon, fibrous graphite, acetates, acrylics (including acrylonitrile), aliphatic polyamides (e.g. nylon), aromatic polyamides, olefins (e.g., polypropylenes, polyesters, ultrahigh molecular weight polyethylenes), polyurethanes (e.g., Spandex), alpha-cellulose, cellulose, regenerated cellulose (e.g., rayon), jutes, sisal, vinyl chlorides, vinylidenes, flax, and thermoplastic fibers;

Metal fibers, e.g., aluminum, boron, bronze, chromium, nickel, stainless steel, titanium or their alloys; and “whiskers”, single, inorganic crystals.

Organic Peroxide

The polymers, copolymers and oligomers of the present invention can be cured without any intended any limitation of the process, at room temperature using a peroxide initiator, UV radiation, or at high temperature in molding processes. When used a peroxide, a variety of peroxide can be used as those listed above used in the polymerization reactions of the present invention.

Curing Accelerators/Promoters

Suitable curing accelerators or promoters may also be used and include, for example, cobalt naphthanate, cobalt octoate, N,N-diethyl aniline, N,N-dimethyl aniline, N,N-dimethyl acetamide, and N,N-dimethyl p-toluidine. Other salts of lithium, potassium, zirconium, calcium and copper. Mixtures of the above may be used. The curing accelerators or promoters are often employed in amounts from about 0.005 to about 1.0 percent by weight, more often from about 0.1 to 0.5 percent by weight, and most often from about 0.1 to 0.3 percent by weight of the resin.

II. Ionizable Compounds

The filled or unfilled substrate is coated with an ionizable organic compound. The ionizable material may be applied by any know technique such as spraying, dipping, brushing or a combination of thereof. The ionizable organic compound that may be used in the present invention may be composed of various chemical configurations that may include but not limited to organic acids, bases and salts. The ionizable materials that may be used in this invention are known and are described for example in U.S. Pat. Nos. 3,236,679; 5,219,493 and 6,270,853 the disclosures of which are incorporated herein by reference in their entireties. Ionizable material used in this invention include but are not limited to quaternized salts where the cation may form from an salt from by an ammonium, imidazolium, pyridinium, pyrrolidinium, phosphonium and sulfonium. The anion in these salts may be from a moiety such as alkylsulfate, tosylate, sulfate, methanesulfonate, nitrate, bis(trifluromethylsulfonyl)-imide, hexafluorophosphate, trifluoroborate, carboxylic acid, halide or hydroxide. The most preferred ionizable salts are quaternary ammonium salts, whose chemical structure is represented by 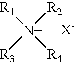
where R₁, R₂, R₃ and R₄ may be the same and are selected from a branched or unbranched alkyl or alkenyl chain having from 1 to 20 carbon atoms. R₁ and R₂ or R₃ and R₄ or combinations of them, may be joined together to form an alkylene group of from 2 to 7 carbon atoms, often 2 to 5 carbon atoms, where they form a 3- to 8-member ring, often 3 to 6 member ring. X represents a linking moiety selected from the group consisting of —O—, —CONH—, or —COO—.

Examples of suitable quaternary ammonium salts include but are not limited to stearyldimethylethylammonium ethylsulfate, stearamidopropyldimethyl-β-hydroxyethyl ammoniumnitrate, N,N,-bis(2-hydroxyethyl)-N-(3′-dodecyloxy-2′-hydroxypropyl)methylammonium methylsulfate, tricaprylmethyl ammonium chloride, ditallow dimethyl ammonium salt, tributyl ammonium methyl sulfate, trihexyltetradecylphosphonium bis(2,4,4-trimethylpentyl)phosphonate, trihexyltetradecylphosphonium bromide, trihexyltetradecylphosphonium chloride, trihexyltetradecylphosphonium decanoate, trihexyltetradecylphosphonium hexafluorophosphate, 3(triphenylphosphonio)propane-1-sulfonate, 1-butylpyridinium bromide, 1-butylpyridinium chloride. Other tertiary fatty amines may also be incorporated such as ethoxylated amines derived from coco, soya, tallow or stearyl amines.

The ionizable compound may me applied as a pure material or in solution in a variety of aliphatic, cycloaliphatic or aromatic solvents. Exemplary solvents include methanol, butanol, isopropanol, acetone, methyl ethyl ketone, toluene, xylene, hexane, cyclohexane, ethylene glycol, nomomethyl ether, diethylene glycol monomethyl ether, butyl acetate, and ethyl acetate. The ionizable compounds may be contained in a solvent solution in a concentration from about 0.05 precent to about 95 precent.

III. Powder Coating Composition

Once the substrate was coated with the ionizable compound, the appropriate electrostatically charge powder coating is directly applied over the substrate. A variety of powder coating may be used and may include but are not limited to polymers and copolymers of polyesters, epoxides, polyacrylates, polystyrene and combinations thereof. For example, a typical composition comprises an acid group-containing acrylic polymer reacted with a curing agent, triglycidyl isocyanurate (TGIC). As another example, U.S. Pat. No. 4,499,239 to Murakami et al., the disclosure of which is incorporated herein by reference in its entirety, proposes a composition comprising 60 to 97 percent by weight of a linear polyester resin having an acid number of 15 to 200 mg KOH/g and 3 to 40 percent by weight of a glycidyl group-containing acrylic polymer, and optionally is modified with a vinyl monomer such as methyl methacrylate. Powder coating compositions comprising a copolymer of glycidyl methacrylate, an ethylenically unsaturated compound, and a crosslinking agent formed in an anhydride of a dicarboxylic acid are proposed in U.S. Pat. Nos. 3,758,632, 3,781,379, 2,888,943 and 4,091,049 to Labana et al., the disclosures of which are incorporated herein by reference in their entireties. Other alternatives are proposed in U.S. Pat. Nos. 5,436,311 and 5,525,370 to Hoebeke et al., U.S. Pat. Nos. 4,242,253 to Yallourakis, and 5,491,202 to Umehara et al., and U.S. Pat. Nos. 6,093,774 and 6,310,139 to Dumain et al., the disclosures of which are incorporated herein by reference in their entireties.

The powder coating may be clear or contain pigments in an amount often from 0.1% to 50% by weight. Suitable pigments include but are not limited to titanium dioxide, iron dioxide, organic dyestuffs, carbon black, etc. Metallic pigments such as aluminum may be included to provide metallic appearance.

The coated powder film deposited over the substrate is baked or cured by a conventional method at a temperature often from about 110° C. to about 250° C. for at least 5 minutes and often from 5 to about 60 minutes to give the cure film a superior appearance and aesthetics. Once the powder coating film has been cured, additional coats may be applied for example of a clear non-pigmented powder or a powder coating with a different pigmentation. The second coat of the polymeric coating is applied over the first coat of the powder coating at a temperature below the crosslinking temperature of the second coat of polymeric powder coating. A preheating step may be carried out for the second coating materials if desirable to assure that the article is at an appropriate temperature prior to applying the second coating material. After applying the second coating material, the article is cured at a curing temperature that is between the minimum crosslinking temperature of the second coat of powder coating and the melting point temperature of the article.

The single or multiple layers of powder coated films provide better protection against damage, low VOC emissions, better aesthetics, better UV performance, cost savings, non-hazardous exposure of toxic chemicals to employees, better depth appearance. The multiple layers provide better aesthetics and depth perception from between layers since a combination of clear coat and pigmented coat may be used alternatively during applications.

There are other methods that optionally may be used in this invention. For example, the substrate may be preheated to an appropriate temperature such that the substrate will not suffer of any decomposition of deformation. Examples of this process are provided for example in U.S. Pat. No. 6,921,558 and U.S. Published Application No. 2004/0253373, the disclosures of which are incorporated herein by reference in their entireties. Once the substrate is at a desired temperature, the powder coating material is deposited as a thin film and then baked or cured.

Other methods of curing the powder coating materials that can be used in this invention also include curing of the powder film by radiation such as UV, visible light or other means of radiation. Examples of this process are found in U.S. Pat. No. 5,824,373, the disclosure of which is incorporated herein by reference in its entirety.

IV. Image Application

The invention also provides a substrate such as a for example: sinks, shower walls, shower pans, simulated tile walls, soap dishes, bathtubs, integral bowls, ceiling and floor tiles, columns, decorative moldings, furniture, countertops and decorative edge treatments for any of the above, panel for building and construction applications exterior parts, etc., that may have a creative and custom-made image or design over at least one surface of the substrate. This method may be accomplished by using a heat transfer sheet with a specified design that thermally can be transfer onto the surface of a substrate. Examples of this process are found in U.S. Pat. Nos. 6,120,635; 4,980,224; and 4,496,618, and U.S. Published Application No. 2005/0163993; the disclosures of which are incorporated herein by reference in their entireties.

Images such as pictures, photographs and printed matter are applied to the outer surface of the substrate components. These images can be applied as paints, inks, dyes, decalcomania, and the like. For example, the images are first applied to a carrier sheet which is then pressed against a surface of the substrate, with the image located between the substrate and the sheet, so as to cause the sheet, and therefore the image, to conform to the contours of the surface of the substrate. A vacuum suction system may be used in order to remove any entrapped air. This procedure permits the complete attachment of the film on the piece and the perfect result of the print. The image is then caused to transfer to the surface of the substrate and become fixed thereto by the application of the heat to a temperature between 50° C. to 250° C. During the application process, the temperature, pressure and vacuum as required, should be constant for the entire duration. The selection of the temperature, pressure, and vacuum will be within the skill of one in the art.

After the image is applied to the target surface, the product embodying the target surface is disengaged from the apparatus, and set to cool. The heat transfer carrier sheet is then removed from the product, typically by peeling the heat transfer carrier film away therefrom. Additional applications from a powder coating may be used thereon and heated again at suitable temperatures for a suitable duration. Typically, the temperature and time variables may be in the range from 110° C. and 250° C., and from 5 minutes to 60 minutes respectively. The specific values of those variables may depend on the characteristics of the product, including the material composition, thickness and overall dimensions, and for any particular product the selection of which will be within the skill of one in the art.

The following examples are merely illustrative of the invention, and are not limiting thereon.

### EXAMPLES

Described below are the resins and intermediates used in the preparation of the substrates and the powder coatings.

Polylite 32141-00 is a DCPD type unsaturated polyester available from Reichhold, Inc. Marblend filler is calcium carbonate available from Imerys. Fine-Clad A-257 is an acrylic powder coating available from Reichhold, Inc. Dodecanedioic acid is available from DuPont. Troy Powdermate EX-570 is a flow agent and Troy Powdermate EX-542 is a degassing agent both available from Troy Corporation. Tinuvin 900 is a UV absorber and Tinuvin 770 is a hindered amine light stabilizer; both are available from Ciba.

### Examples of Powder Coatings Applied to Composite Substrates using Ionizable Material

### Examples 1-3

The following Examples illustrate the practice of the present invention. The Examples should not be construed as limiting the invention to anything less than which is disclosed. Percents (%) and parts are by weight unless otherwise indicated. Composite sink formulation—three sinks based on Polylite 32141 were made. The sink formula is as follows:

| | |
|---|---|
| PolyLite ® 32141 polyester resin | 2190.0 g |
| Marblend filler | 6570.0 g |
| Methyl ethyl ketone peroxide | 20.0 g |

The three sinks were coated per the following general steps.

A) Apply conductive solution CTI 3314-B at room temperature via liquid spray gun.

B) Allow solvent to evaporate.

C) Apply a high gloss acrylic clearcoat (kV's=79, fluiding PSI=10, atomizing PSI=1 5). The acrylic powder coating has the following composition:

| Base Resin | wt (g) |
|---|---|
| FINE-CLAD A-257 acrylic resin | 84 |
| Curing Agent | |
| Dodecanedioic Acid | 16 |
| Flow Agents | |
| Troy Powdermate EX-570 | 2.5 |
| Degassing Agent | |
| Troy Powdermate EX-542 | 0.5 |
| UV Absorber | |
| Tinuvin 900 | 0.8 |
| Hindered Amine Light Stabilizer | |
| Tinuvin 770 | 0.4 |

D) Place part in oven to cure. See Table 1 for details. These sinks were tested in accordance with ANSI Z124.3 (Thermal Shock Resistance). Physical test results are also in Table 1.

TABLE #1
Acrylic Powder Coated Composite Sink Performance Data

| | Coating Cure | | Time to Failure |
|---|---|---|---|
| Example | Cycle | Appearance | (Crack Evolution) |
| 1 | 20 minutes at | Excellent | 137 cycles |
| | 120° C. | | |
| 2 | 60 minutes at | Excellent | 549 cycles |
| | 120° C. | | |
| 3 | 60 minutes at | Excellent | >500 cycles (test stopped at |
| | 150° C. | | 500 with no damage) |

### Examples 4-6

Three flat composite panels were made with the same composition as the sinks described above. Further, they were made conductive with the same ionizable material, and subsequently powder coated with the acrylic clear coating, and cured as shown in Table 2 below. Infrared curing was achieved with a medium-wave IR lamp made by Infratech, Inc. After the coatings were cured, they were then subjected to an image transferring process. The panels were tested for UV resistance in a QUV Accelerated Weather Tester (Q Panel Lab Products Company, Cleveland, Ohio) with A-340 bulbs. The QUV Tester was operated under the following cycle conditions: Humidity cycle: 4 hours at 50° C., UV cycle: 4 hours at 60° C.

TABLE #2
Acrylic Powder Coated Flat Panels with Image Transfer

| | Coating | Appearance | 60° Gloss retention |
|---|---|---|---|
| Example | Cure Cycle | after curling | after 2000 hours |
| 4 | Infrared: 15 | Excellent | 100% |
| | minutes @ | | |
| | 12″ part | | |
| | distance, | | |
| | Convection: | | |
| | 20 minutes | | |
| | at 120° C. | | |
| 5 | Infrared: 20 | Excellent | 100% |
| | minutes @ | | |
| | 12″ part | | |
| | distance, | | |
| | Convection: | | |
| | 15 minutes | | |
| | at 120° C. | | |
| 6 | 30 minutes | Excellent | Not tested |
| | at 120° C., | | |
| | convection | | |
| | oven | | |
| Image | | | <100 hours to 50% gloss loss |
| Transfer | | | |
| Control with | | | |
| Gel Coat | | | |

The foregoing is illustrative of the present invention, and is not to be construed as limiting thereof. The invention is defined by the following claims, with equivalents of the claims to be included therein.

That which is claimed:

1. A thermoset polymer substrate having applied thereto an ionizable compound and an electrostatic powder coating.

2. The substrate according to claim 1, wherein the ionizable compound is a quaternized salt.

3. The substrate according to claim 2, wherein a cationic portion of the quaternized salt is selected from the group consisting of ammonium, imidazolium, pyridinium, pyrrolidinium, phosphonium, and sulfonium salts and the anionic portion is selected from the group consisting of alkylsulfate, tosylate, sulfate, methanesulfonate, nitrate, bis(trifluoromethylsulfonyl)imide, hexafluorophosphate, trifluoraborate, carboxylic acid, halide and hydroxide.

4. The substrate according to claim 1, wherein the powder coating is selected from the group consisting of polymers and copolymers of polyesters, epoxides, polyacrylates, polyurethanes, polyethers, polystyrene, and combinations thereof.

5. The substrate according to claim 1, wherein the ionizable compound or powder coating includes a compound for enhancing conductivity.

6. The substrate according to claim 5, wherein the compound for enhancing conductivity is graphite particles.

7. The substrate according to claim 1, wherein the substrate includes a compound for enhancing conductivity.

8. The substrate according to claim 7, wherein the compound for enhancing conductivity is carbon black or a conductive metal.

9. An article of manufacture made from the substrate according to claim

10. A thermoset polymer substrate having an image on at least one surface thereof, said substrate having applied thereto an ionizable compound, an electrostatic powder coating, and a carrier for transferring the image thereon.

11. The substrate according to claim 10, wherein the ionizable compound is a quaternized salt.

12. The substrate according to claim 11, wherein a cationic portion of the quaternized salt is selected from the group consisting of ammonium, imidazolium, pyridinium, pyrrolidinium, phosphonium, and sulfonium salts and the anionic portion is selected from the group consisting of alkylsulfate, tosylate, sulfate, methanesulfonate, nitrate, bis(trifluoromethylsulfonyl)imide, hexafluorophosphate, trifluoraborate, carboxylic acid, halide and hydroxide.

13. The substrate according to claim 10, wherein the powder coating is selected from the group consisting of polymers and copolymers of polyesters, epoxides, polyacrylates, polyurethanes, polyethers, polystyrene, and combinations thereof.

14. The substrate according to claim 10, wherein the ionizable compound, or powder coating includes a compound for enhancing conductivity.

15. The substrate according to claim 14, wherein the compound for enhancing conductivity is graphite particles.

16. The substrate according to claim 10, wherein the substrate includes a compound for enhancing conductivity.

17. The substrate according to claim 16, wherein the compound for enhancing conductivity is carbon black or a conductive metal.

18. An article of manufacture made from the substrate according to claim

19. A method of providing a powder coating composition on a thermoset polymer substrate, said method comprising the steps of:
a) applying an ionizable compound to at least one surface of the substrate; and
b) applying an electrostatic powder coating composition on the ionizable compound on at least one surface of the substrate.

20. The method according to claim 19, further comprising the step of subjecting the substrate to conditions sufficient to cure the electrostatic powder coating.

21. The method according to claim 20, wherein the conditions sufficient to cure comprises heating to a temperature of 110° C. to 250° C.

22. The method according to claim 20, wherein the conditions sufficient to cure comprises subjecting the coating on the substrate to UV or visible light.

23. The method according to claim 20, further comprising applying an image on the surface of the substrate having the ionizable compound and the powder coating thereon.

24. An article of manufacture made according to claim 23.

25. A method of providing an image on at least one surface of a thermoset polymer substrate, the method comprising the steps of:
a) applying an image on at least one surface of the substrate;
b) applying an ionizable compound to at least one surface of the substrate;
c) applying an electrostatic powder coating composition on the ionizable compound on at least one surface of the substrate; and
d) subjecting the substrate with the image thereon to conditions sufficient to cure the electrostatic powder coating.

26. The method according to claim 25, wherein the conditions sufficient to cure comprises heating to a temperature of 110° C. to 250° C.

27. The method according to claim 25, wherein the conditions sufficient to cure comprises subjecting the coating on the substrate to UV or visible light.

28. The method according to claim 25, further comprising applying an image on the surface of the substrate having the ionizable compound and the powder coating thereon.
